(19) United States
(12) Patent Application Publication
(10) Pub. No.: US 2016/0277265 A1
(43) Pub. Date: Sep. 22, 2016

(54) DISTRIBUTED STABILITY AND QUALITY MONITORING, TESTING, AND TRENDING OF DATA COMMUNICATIONS NETWORKS

(71) Applicant: Alexis David Paradela, Weston, FL (US)

(72) Inventor: Alexis David Paradela, Weston, FL (US)

(21) Appl. No.: 15/075,470

(22) Filed: Mar. 21, 2016

Related U.S. Application Data
(60) Provisional application No. 62/099,273, filed on Mar. 22, 2015.

(51) Int. Cl. H04L 12/26

(52) U.S. Cl. CPC H04L 43/08; H04L 43/50

(57) ABSTRACT

The present invention is a system, apparatus, and method for assessing the performance and quality of communications across networks, and possibly acting on the results of such assessment. Embodiments of the invention are contemplated to comprise a data network, a first computing host, a second computing host, a test management infrastructure engine, and a user interface. The first and second computer hosts are operably connected as nodes on the data network. The test management infrastructure engine is operably connected to one or both of the first and second computing host. Finally, the user interface is operably connected to the test management infrastructure engine. Embodiments of the invention are configured to manage, deliver, execute, analyze, and act on a one or more test enabling the system to detect and act upon issues impacting components of the data networks used by system users.

### CROSS-REFERENCE TO RELATED APPLICATIONS

This non-provisional patent application claims the benefit of priority to U.S. Provisional Patent application No. 62/099,273 filed on Mar. 22, 2015, which is currently pending and is incorporated by reference as if fully set forth herein.

### FIELD OF THE INVENTION

The invention disclosed broadly relates to the field of data network communications, and more particularly relates to the field of assessing the performance and quality of communications across such networks, and possibly acting on the results of such assessment.

### BACKGROUND OF THE INVENTION

Private and public data communications networks connect millions of computing hosts. There are at least two computing hosts participating in every communications session across a data network. It is common for many applications or processes executing on a computer host to communicate across these data networks to reach resources on other hosts. Examples of applications or processes that commonly use resources on other hosts reachable via data communications networks include web browsers, database clients, home appliances, social media applications, air conditioning thermostats, data backup agents, security cameras, building management systems, file sharing clients and servers, telephony and video conferencing components.

The performance and quality of the communication paths provided by the data network used by the clients, server, and components directly impact the performance of applications or processes which rely across such network. Problems such as packet loss or latency can negatively impact processes and applications. Computing processes and applications vary widely in their tolerance to network communications issues. For example, variations in the time it takes for a packet to traverse a network (defined as jitter) can negatively affect the quality of a video data stream, but may be imperceptible to a user client loading a simple page from a web server such as Apache.

Because network communications protocol components may automatically re-transmit data packets if issues are detected without the involvement of the host operating system, processes or applications, many communications issues are not obvious to the application or processes executing on the computing hosts. Even when detected, metrics and statistics of these communication issues are normally not documented or readily reported by applications or processes. Also, the root cause of communications issues are difficult to pinpoint because they can be caused by applications, computing processes, components, or circumstances on the host itself, including resource depletion such as memory or processing capacity.

The symptoms of a communications session gathered from a single pair of computing hosts is generally not relied on to gauge the health or performance of a data communications network, diagnose a network problem, or find the root cause of such problem because the application or hosts themselves, or related components, can be introducing or amplifying the problem. For example, a host involved in a data communications session where the CPU is running at 100% load due to a rogue application or process can easily cause network performance or other quality issues for applications or processes running on the host, or the performance of processes or applications executing on other hosts relying on it for any reason.

Existing network performance testing systems and methods are generally limited in their ability to efficiently detect data network issues because they do not use information from a plurality of diverse components connected via different network providers, located in multiple physical locations, using different technologies, or other variables in order to detect or report patterns or commonality.

Therefore, there is a need for an end to end data network testing solution which aims to overcome the above-stated shortcomings of the known art.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the disclosure with reference to the drawings, in which:

FIG. 1 is a simplified high-level block diagram illustrating an exemplary network performance testing system configured to operate according to one embodiment of the present disclosure;

FIG. 2 is a high-level flowchart of a network performance testing method from the point of view of the tool, according to an embodiment of the present disclosure;

FIG. 3 is a high-level flowchart of the network performance testing method of FIG. 2, from the point of view of the Data Agent, according to another embodiment of the present disclosure;

FIG. 4 is a simplified block diagram of the components of a hardware embodiment of a Data Agent, according to an embodiment of the present disclosure; and

FIG. 5 is a simplified depiction of an exemplary user interface, according to an embodiment of the present disclosure.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present disclosure.

### DETAILED DESCRIPTION

Before describing, in detail, embodiments that are in accordance with the present disclosure, it should be observed that some of the embodiments may reside primarily in combinations of method steps and system components related to systems and methods for placing computation inside a communication network. Accordingly, the system components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible computing or communications embodiment may not be depicted in order to facilitate a less obstructed view of these various embodiments.

We describe an embodiment of the present invention comprising a system that is agnostic with respect to network technology, computing device, and telecommunications carrier. The system provides independent testing of the performance and quality of the data communications network components, while detecting data network issues via the analysis of instruction results from one or more sources against thresholds or patterns using one or more strategies such as simple logic, statistics, or correlation. The system and method as discussed herein provide a technological improvement in the field of network communications by introducing a carrier- and technology-agnostic solution that provides distributed data network performance and quality testing, analysis, trending, and actions.

In addition, we introduce a further technological advantage by gathering the results of communication tests across a plurality of hosts, allowing the analysis of such results to be fed into a machine learning module in order to accurately detect communication issues so they can be addressed, sometimes even before it affects performance of applications and processes executing on hosts systems located on such networks. The system disclosed herein proposes a flexible system for performance and quality testing of data communications networks.

One embodiment allows for a distributed system that uses the current and past communications test results from one or more Data Agents 102 to gauge the stability and quality of the communications, shows a results pattern, and suggests to the user the likely component that is the root cause of the issue.

System 100

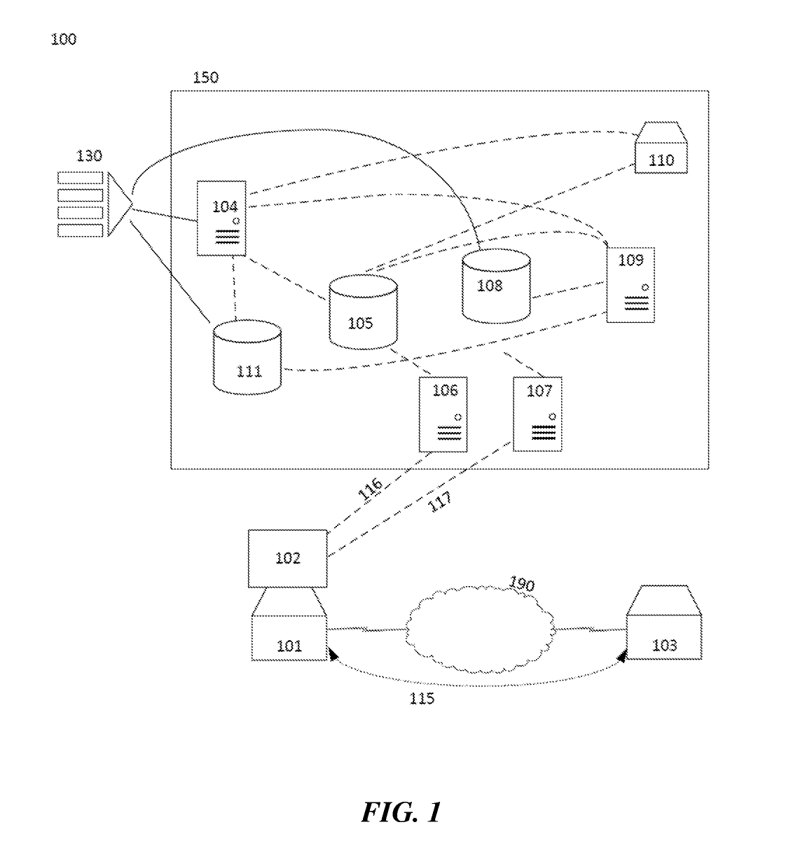

Referring now in specific detail to the drawings and to FIG. 1 in particular, there is shown a simplified block diagram illustrating, according to an embodiment of the present disclosure, a distributed System 100 configured to manage, deliver, execute, analyze, and act on a wide range of tests whereby the System 100 detects issues impacting components of the data networks used by system users.

System 100, as depicted herein, includes the representation of any number of networked computing hosts where a minimum of two hosts communicate over one or more public, private, or a combination of data networks, shown as Data Network 190. In one embodiment, System 100 includes, inter alia: a Test Management Infrastructure Engine 150 (“TMIE”), a User Interface 130, and at least two computing hosts 101 and 103, with at least one of the computing hosts configured as a Data Agent 102.

Test Management Infrastructure Engine 150

The Test Management Infrastructure Engine (“TMIE”) 150 components can be realized each as one or more computing devices, executing a variety of scripts, databases, processes, and related components. Components of the TMIE 150 shown in FIG. 1 are for illustrative purposes only, to facilitate an understanding of the services and features of TMIE 150. One with knowledge in the art will appreciate that the components may represent all hardware components, all software components, or a combination of hardware and software components.

At a high level, TMIE 150 generates Instructions 116, which one or more Data Agent 102 downloads, processes, and executes. The Data Agent 102 then uploads the output created by executing the instructions, processes and applications called for in the instructions 116 as Result 117 back to the TMIE 150, which then interprets, records, analyzes, and acts upon, to be described in detail later in this document.

Instructions 116 may include instructions for the Data Agent 102 to process in order to, among other things, measure data network performance and quality tests, such as: basic reach-ability, latency, jitter, packet loss, Internet Protocol (IP), Transmission Control Protocol (TCP) performance, User Datagram Protocol (UDP) performance, and Domain Name Service (DNS) name resolution, to name a few.

In another embodiment of the invention, Instructions 116 could also include instructions for the Data Agent 102 to perform ore or more of the following: Data Agent 102 cleanup functions and verifications, reset processes, software upgrades, report of basic acknowledgement, report operating metrics and process status.

Also at a high level, TMIE 150 uses the instruction results 117 from multiple Data Agents 102 to identify result correlation and trending related to network issues. TMIE 150 can then trigger actions including modifying instructions executed by TMIE 150 components or Data Agents 102, or trigger other actions or notifications of various types, technologies, and methods to be described in detail later in this document.

It should be noted that TMIE 150 could also use lack of response from one or more Data Agents 102 as part of the data set used for diagnosis, correlation and trending, and take further actions as described in this document.

TMIE 150 comprises the following components: an Instructions Definition Engine 104 which translates user inputs and other conditions into instructions to be stored in the Instruction Database 105, an Instruction Generator 106 for creating the detailed instructions files and packaging and managing the delivery of such Instructions 116 to the Data Agent, a Result Interpreter 107 for interpreting the Result 117 of the instructions output from Data Agent, a Result Database 108, and a Correlation and Trending Engine 109. The Result Interpreter 107 reads the raw results of the instructions uploaded by the Data Agent 102 and parses the test result details into the Result Database 108. The Correlation and Trending Engine 109 mines the Results Database 108 for patterns and events, then writes the determinations into the Instructions Database 105. The Correlation and Trending Engine 109 can have the capability to function using machine learning model components, correlating and analyzing the results in order to refine subsequent test instructions.

It will be readily apparent to those with knowledge in the art that the functionality implemented within the blocks illustrated in the diagram may be implemented as separate components or the functionality of several or all of the blocks may be implemented within a single component. For example, the functionality for the Instruction Definition Engine 104 and Instruction Generator 106 may be included in the same component. As another example, the functionality of the Correlation and Trending Engine 109 may be distributed among various separate components or computing hosts.

It will also be readily appreciated that the TMIE 150 may also include computing hardware and functionality required to perform network testing. The hardware and functionality required to perform network testing are well known to those with knowledge in the art and thus are omitted from the diagram shown in FIG. 1.

According to one embodiment, the Instruction Generator 106 is a set of computing processes executing on one or more computers running an operating system such as Linux®. The Instruction Generator 106 scans the Instruction Database 105 and generates a detailed Instruction 116 available for the Data Agent 102 to execute. The Instruction 116 lists criteria for the Data Agent 102 to follow, including but not limited to: which data agent is to run the instruction, how often the instruction should be run, and parameters of the instruction including type, frequency, destination, and size of transmission.

According to one embodiment, the Result Interpreter 107 is a set of computing processes executing on one or more computers running an operating system such as Linux® or Windows Server. The Result Interpreter 107 receives the test Result 117 uploaded by the Data Agent 102. This Result 117 is processed by the Result Interpreter 107 and the results are then mapped to specific data points which are written to the Result Database 108. For example, the Result 117 for a basic TCP reach-ability test can include the details of the instruction 116 downloaded by the Data Agent 102, confirmation that the instruction was run, time when the instruction was started, time when instruction ended, percentage of success, and latency values for each attempt.

In one embodiment, the Data Agent 102 is a dynamic set of computing processes and scripts operating on Host Computer 101 which is connected to Data Network 190.

In another embodiment, the Data Agent 102 is a dedicated hardware device connected to Data Network 190.

The Data Agent 102 frequently downloads Instructions 116 from Instruction Generator 106, executes scripts and processes that may run reachability, performance, and quality tests against at least one destination reachable across Data Network 190, and uploads results 117 to Result Interpreter 107. It should be noted that the System 100 is not limited to one Data Agent 102, and in fact many more Data Agents 102 are expected and are required for some of the functions provided by embodiments of the invention, such as correlation. As computing architecture and network technology changes over time, the type, number, and frequency of tests, and the throughput of data packets which are executed by Data Agent 102 will change accordingly.

Instruction 116 can include: scheduling information, type of test, destination address, and specifications including, but not limited to, one or more of the following: direction of data transmission, size of transmission, size of transmission, frequency of test, timeout values.

FIG. 1 shows a Data Agent 102 executing on host computer 101 downloading Instruction 116 where instructions include commands to communicate to a host computer 103 which may or may not have a Data Agent 102.

For example, Instruction 116 may include commands for a Data Agent 102 on host computer 101 to use an application which uses ICMP such as PING to test basic connectivity against a defined destination. However, the exemplary embodiment is not limited to the Instruction 116 including commands for Data Agent 102 to execute tests using ICMP packets, and the Data Agent 102 often uses other protocols towards network performance and quality tests. For example, the Data Agent 102 can use Internet Protocol (IP) and/or one or more of its sub-components such as User Datagram Protocol (UDP) or Transmission Control Protocol (TCP) to test for packet loss, as an example.

In other embodiments, Instruction 116 may include multiple instructions for Data Agent 102 to process and execute.

In other embodiments, a Data Agent 102 executing on host computer 101 can perform tests against another Data Agent 102 on host computer 103 for more complex tests, such as detecting network packets arriving out of order when using the UDP data networking protocol.

In one embodiment, the logical network flow of the communications 115 between computing host 101 and 103 is depicted as a dotted line. It should be noted that at least one or both of the computer hosts represented as 101 or 103 is configured as a Data Agent 102. For purposes of this disclosure, the terms “download” and “upload” represent any methods of data transfer including but not limited to: FTP, HTTP, SCP, or SMB.

Data Network 190 comprises a single or a plurality of connected data networks, including private and public networks, including the Internet, and such networks may or may not be comprised of circuits or components across multiple business entities, service providers, physical and protocol layer data networking methods and technologies, and located across diverse physical locations.

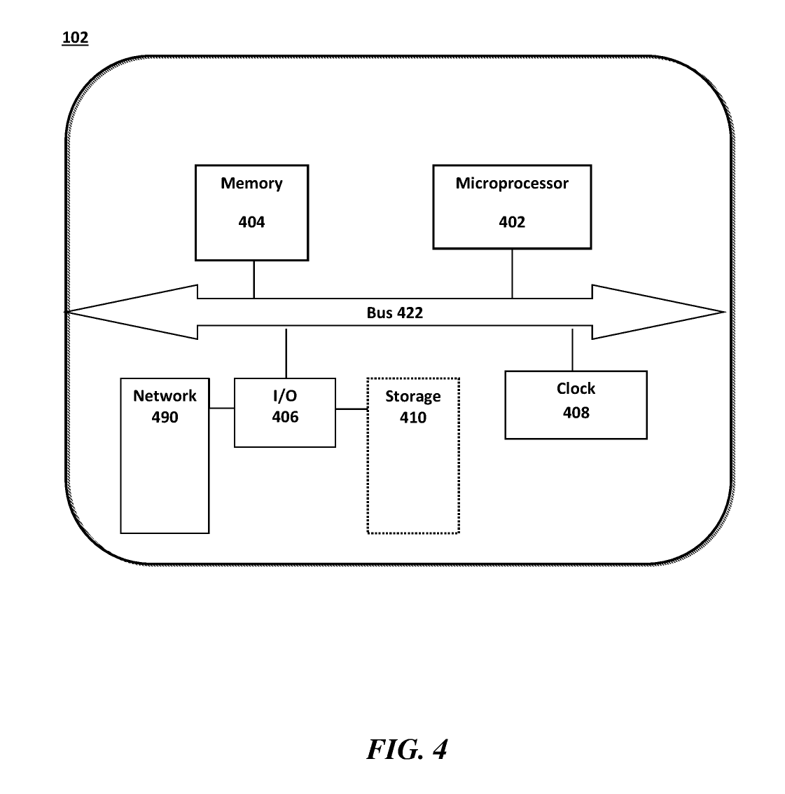

In one embodiment, referring now to FIG. 4, the Data Agent 102 comprises a physical computing device configured with network connectivity, such as Ethernet IEEE 802.3, Wireless such as IEEE 802.11, or Cellular Wireless such as GSM. Such dedicated computing device further comprises a microprocessor device 402 which communicates with an input/output subsystem 406, memory 404, storage 410 and network interface 490. The microprocessor device 402 is operably coupled with a communication infrastructure herein represented as bus 422. Bus 422 is a simplified representation of the communication infrastructure required in a device of this type. One with knowledge in the art will appreciate that a control bus, address bus, and data bus can all be included with the components of Data Agent 102.

The microprocessor device 402 may be a general or special purpose microprocessor operating under control of computer program instructions executed from memory 404 on program data. The microprocessor 402 may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory 404 that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. Memory 404 may include both volatile and persistent memory for the storage of: operational instructions for execution by Microprocessor 402, data registers, application storage and the like. The computer instructions/applications that are stored in memory 404 are executed by processor 402. The I/O subsystem 406 may comprise various end user interfaces such as a display, a keyboard, and a mouse. The I/O subsystem 406 comprises a data network interface 490. The network interface 490 allows software and data to be transferred between the Data Agent 102 and external hosts or devices. Examples of network interface 490 can include one or a plurality of: Ethernet network interface card, wireless network interface card, network interface adapter via USB, wireless cellular modem, and the like. Data transferred via network interface 490 are in the form of signals which may be, for example, electronic, electromagnetic, radio frequency, optical, or other signals capable of being transmitted or received by network interface 490.

In another embodiment, the Data Agent 102 can be configured as a special-purpose microcontroller which has access to and executes Instruction 116 to perform performance and quality tests against one or more destinations reachable via Network 190.

For purposes of this disclosure, Data Agent 102 may also represent any type of computer, information processing system, or other programmable electronic device, including a client computer, a server computer, a portable computer such as a laptop device, an embedded controller, a software or microcode embedded in devices or appliances such as a mobile telephone such as an Apple iPhone, Television sets, Air Conditioning thermostats, home alarm systems, application-specific integrated circuit (ASIC), special-purpose microcontrollers, and the like that has been specially programmed to perform the functions of the Data Agent 102 as disclosed herein.

In one embodiment, Data Agent 102 is made up of processes, scripts, and instructions which download instructions from the Instruction Generator 106 and executes such instructions which may be designed to measure the performance or quality of tests across Data Network 190, such as TCP port 80 reachability.

System 100 components including TMIE 150 and Data Agent 102 can be “hardened” to prevent unauthorized access, use, or control via one or more methods. In one embodiment, communications between the TMIE 150 and the Data Agent 102 can be encrypted or employ one or more verification methods and protocols, such as security certificates, access control lists, and the like. Data Agent 102 unused operating system and application components, features, processes, firmware, file systems, and/or hardware ports can be modified, restricted, disabled, or removed in order to improve the security and protection of the Data Agent 102.

User interface 130

The User Interface 130 is a user-facing visual interface operably coupled with the TMIE 150. This User Interface 130 is made up of components that System 100 users can use to manage settings and configurations of System 100 components and data sets. Through this User Interface 130, a user conveys the desired System 100 configuration, tests, threshold, and action parameters, including, but not limited to: Data Agent 102 unique identifier, Data Agent 102 primary network interface media access control (MAC) address, physical location, network service provider in use, and other parameters. Some of the test parameters can include: test type, test frequency, thresholds, and threshold violation actions. Options displayed or available on the User

Interface 130 may be coupled to the user subscription level or type.

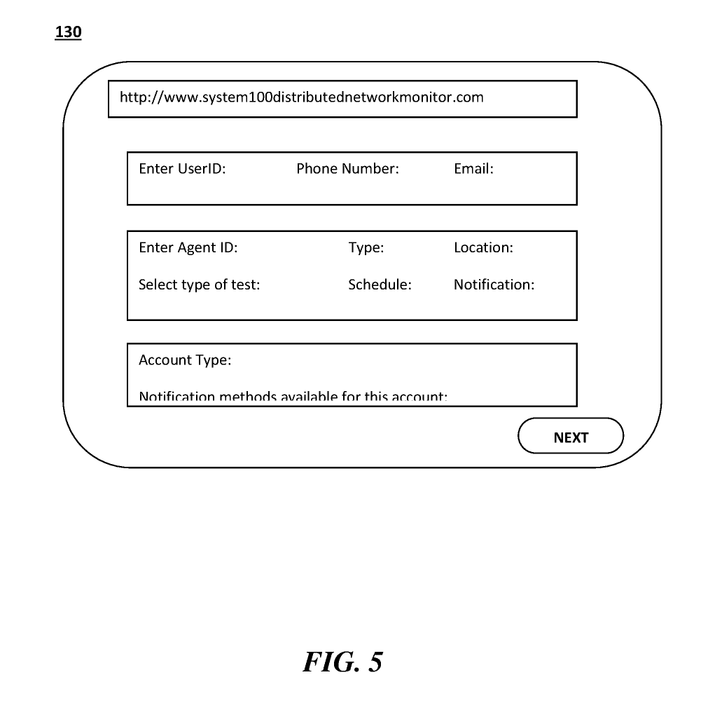

Referring now to FIG. 5, in one embodiment the User Interface 130 can be implemented as a Graphical User Interface accessible via a Web Browser connecting to a web page hosted on a web server, such as Apache. The user can select various options through the User Interface 130. FIG. 5 illustrates just a few of these options.

The user can input account information, including location, as well as select the types of tests to run, the frequency of the tests, and the type of notification to use. The users' selections and input on the User Interface 130 can determine the instructions produced by the Instruction Generator 106 for the Data Agent to execute.

Through User Interface 130, TMIE 150 can output instruction results, correlation information, logging, and other information to the user from any TMIE 150 component including the Results Database 108 or the Settings Database 111. The specifics of the options available or information provided on User Interface 130 can vary based on the subscription level of the user.

Instructions Definition Engine 104

In one embodiment, Instructions Definition Engine 104 is a set of computing processes that translates the information provided through the User Interface 130 into instruction parameters to perform tests or other functions, or thresholds to trigger alarm definitions and actions, stored in Instruction Database 105. In one embodiment, a user can specify via the User Interface 130, processed by Instructions

Definition Engine 104, and stored in the Instructions Database 105 that a specific Data Agent 102 is to run a Domain Name System lookup of, for example, www.foo.com. every 15 minutes, and if there is a DNS lookup failure or error, send an electronic mail to a specific destination with the technical details related to the failure or error.

Instructions Database 105

In one embodiment, the Instructions Database 105 stores data provided by Instructions Definition Engine 104 related to Data Agents 102, instructions, test parameters, and result thresholds and actions. The Instructions Database 105 can be hosted on a database management system such as MySQL. The exemplary embodiment is not limited to using MySQL and other database platforms could be used, such as Oracle.

Data values to be stored in the Instructions Database 105 include but are not limited to: User unique identifier, Data Agent 102 unique identifier, Data Agent 102 media access control (MAC) address, Data Agent 102 physical location, Data Agent 102 network or Internet service provider information, and others. In addition, the

Instructions Database 105 also stores parameters related to the instructions and tests to execute including: Data Agent 102 unique identifier, test type such as DNS, ICMP, or UDP performance, test frequency such as hourly, specific test parameters such as IP address or packet size, test result value threshold parameters such as UDP performance less than 3 mbps, and actions to take if such thresholds are violated such as sending an SMS message to the user.

Result Interpreter 107

In one embodiment, a Result Interpreter 107 is a set of computing processes executing on one or more computers running an operating system such as Linux®. The Result Interpreter 107 processes the test Result 117 uploaded by the Data Agent 102, and the Result 117 are mapped to specific data points which are written to the Result Database 108. For example, the Result 117 for an ICMP reach-ability test can include the test instruction string downloaded by the Data Agent 102, confirmation that the test was run, time when the test was started, time when the test ended, percentage of success for the ICMP reach-ability, and latency values for each ICMP attempt.

The specifics of how the Result Interpreter 107 processes the Result 117 and converts results to data points vary widely depending on the specific test being executed by the Data Agent 102. For example, to execute an ICMP reach-ability test where application “ping” is used to perform the actual test, the specific relative string character position of the raw data from the last line of the output of the application is used to extract the timing information in milliseconds. This timing data is uploaded to the pre-defined database field in the Result Database 108 configured to store such value for the specific test.

Result Database 108

In one embodiment, the Result Database 108 stores Result 117 information generated by Data Agent 102 after processing by the Result Interpreter 107. The Result Database 108 can be configured and executed on a database management systems platform such as MySQL. The exemplary embodiment is not limited to using MySQL and other database platforms could be used, such as Microsoft SQL Server.

Data values to be held in the Result Database 108 include: User Unique Identifier, Data Agent 102 MAC addresses, date/time reported, date/time downloaded, date/time executed, date/time uploaded, Data Agent 102 IP address, Test Identifier, Test Instructions, and Test Results data points. In addition, the Result Database 108 can store correlation and trending results generated by the Correlation and Trending Engine 109 for reference or use by other components, such as the User Interface 130 or Action Interface Engine 110.

In one embodiment, the Result Database 108 stores values delivered via Result 117 provided by Data Agent 120, where data is stored in type-length-value (TLV) tuples. In TLV, one field is the type of data encoded; the second field is the length of the value; and the third field stores the data representing the value for the [type]. The advantage to this open-ended storage of test result values is that it enables dynamic data storage and mining, where the type and format of the values can change as needed.

Correlation and Trending Engine 109

In one embodiment, the Correlation and Trending Engine 109 frequently queries the Instructions Database 105 and Result Database 108 to find specific data patterns. This logic may use strategies such as a single event such as a threshold violation, a pre-determined pattern of events, or correlation of two or more of these methods from a single or a plurality of test results or Data Agents.

Such data patterns may include any data value stored in the Instructions Database 105 and Results Database 108, and will develop over time as the data sets expand and mature. For example, a long term pattern of the data sets are found to show that latency does not vary more than 10% over a 24 hour period for Data Agents 102 identified as using a specific Internet Service Provider located within a specific geographical location, thus this finding is used to create thresholds for future processing and action.

In addition, lack of communications or response by one or more Data Agents 102 can be detected by querying the Instructions Database 105 and Result Database 108, and used in a similar fashion to declare events based on patterns.

Another example is to detect a pattern and declare an event when all Data Agents residing at a common location such as the same zip code where there are five or more active Data Agents 102 using the same Internet network service provider report DNS lookup failures but can otherwise communicate with no issue via IP addressing.

Once an event is established, such findings are written to the Instruction Database 105 for reporting, analysis, and action by other TMIE 150 components such as but not limited to Instruction Definition Engine 104 or Action Interface Engine 110.

In one example, the Correlation and Trending Engine 109 queries the Instruction Database 105 and Result Database 108, and finds a pattern where Data Agents 102 using a specific Internet Service Provider located in the State of Texas have not reported in the last 30 minutes. Consequently, the Correlation and Trending Engine 109 stores these findings to the Result Database 108. At this point, the Action Interface Engine 110 frequently queries the Instructions Database 105 and finds an event, and begins to execute action jobs to notify qualifying users as defined in the Instructions Database 105.

In a continuation to the above example, the Action Interface Engine 110 then updates the settings in the Instructions Definition Engine 104 to add instructions on the instruction Database 105 to all Data Agents 102 in Texas to run a basic ICMP test against Internet public IP address 2001:4860:4860::80 (an IPv6 address) every two minutes for the next 30 minutes in order to order to gather more data and improve the resolution of the data set in the Results Database 108.

Action Interface Engine 110

In one embodiment, the Action Interface Engine 110 queries the Instruction Database 105 and Result Database 108 for values deemed to indicate that actions are to be executed. Actions may include one or more of the following acts: writing information to a log, sending an e-mail message, sending a message via SMS, sending a Simple Network Management Protocol (SNMP) trap to a destination, or sending a log message via Syslog.

Settings Database 111

In one embodiment, Settings Database 111 stores user information, such as contact, user type and history, and similar data used by other System 100 components such as the User Interface 130 or the Definition Engine 104.

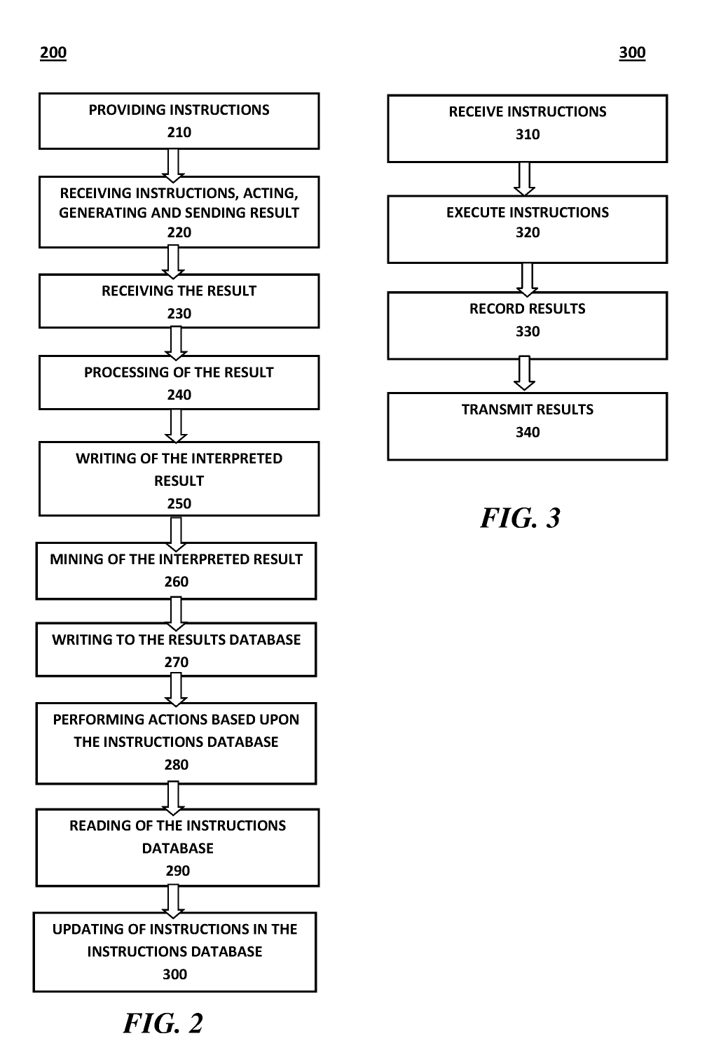

High-Level Flowchart—FIG. 2.

Referring now to FIG. 2, it contains a logical flowchart of the process flow 200 for performance and quality testing of data network communications systems, from the point of view of the TMIE 150, according to an embodiment of the present disclosure. Flowchart 200 is only a high level logical representation of processes as commonly executed and does not cover many conditions or exceptions to such process.

In step 210, Instruction Generator 106 makes Instructions 116 available to the Data Agent. The actual process of how Instruction 116 reaches Data Agent can be managed by the Data Agent via downloading from TMIE, or via TMIE components via a push to the Data Agent.

In step 220, the Data Agent 102 receives Instructions 116 and acts based on Instruction 116, generates Result 117, and sends Result 117 to Results Interpreter 107.

Next in step 230, the Results Interpreter 107 receives Result 117 generated by the Data Agent 102.

Next on Step 240, the Result Interpreter 107 processes the Instruction Result 117 from Data Agent 102 and writes the information to the Result Database 108 on Step 250.

Next on Step 260, the interpreted results stored on the Results Database 108 are mined by the Correlation and Trending Engine 109 to see if any values are found that event thresholds based on single or multiple events, correlation patterns, and statistical analysis, and if so, write the information to the Results Database 108 and Instructions Database 105 in Step 270.

Next on Step 280, the Action Interface Engine performs actions such as notifications based on the threshold violation information stored at the Instructions

Database 108 generated on Step 260

Lastly on Step 290, the Test Definition Engine 104 reads the threshold violation information stored at the Instructions Database 108 generated on Step 280 and may update instructions on the Instruction Database 105 for additional tests to be assigned to Data Agents 102 in Step 300.

High-Level Flowchart—FIG. 3

Referring now to FIG. 3, we show a flowchart 300 of the process for performance and quality testing of data network communication systems, from the point of the view of the Data Agent 102, according to an embodiment of the present disclosure. Flowchart 300 is only a high level logical representation of processes as commonly executed and does not cover many conditions or exceptions to such process.

The input to the process is a set of Instructions 116 produced by the Instruction Generator 106.

On Step 310, the Data Agent 102 obtains the Instructions 116 from TMIE 150. The data transfer involved on this step can be made via any viable protocol, logic, or method, and could be encrypted for security.

Continuing to Step 320, Data Agent 102 processes and executes commands and processes provided by TMIE 150 via Instruction 116.

Continuing to Step 330, the raw output of the commands and processes executed are recorded to a results file. This raw results information varies widely depending on the specifics of the test. For example, tests using ICMP can record metrics showing latency, and tests using UDP can record data packets that are out of order. The information in the Result 117 varies widely depending on the specifics of the test component or application. For example, tests using ICMP can record metrics showing latency, and tests using UDP can record data packets that are out of order.

Finally, on Step 340, the results file is transmitted to TMIE 150 components. The data transfer involved on this step can be made via any viable protocol, logic, or method, and could be encrypted for security.

Further, in view of many embodiments to which the principles of the invention may be applied, it should be understood that the illustrated embodiments are exemplary embodiments and should not limit the present disclosure. Further, unless specified to the contrary, the flowchart steps described above may be taken in a sequence other than those described, and more, fewer or equivalent elements or components than the ones illustrated can be used.

Monetization

Embodiments of the invention can be made available as a monitoring system for providers of public or private data network services, including Internet Service Providers, or managers of private data networks. The System can notify providers where their users are having issues, sometimes even before the users themselves are aware of any problems. Because the invention stores information about the Data Agents 102, such as the communications technology, physical locations, and other information, it can detect trends across technology, geographic area, telecommunications providers, etc. as described herein.

Embodiments of the invention can be provided as a subscription service to users and entities who pay for service levels, and features according to the level and complexity of testing results and notification actions provided. For example, a user may subscribe to receive only results of basic reachability test; or for a higher price, the system may provide improved test results or functionality.

Therefore, while there has been described what is presently considered to be the preferred embodiment, it will be understood by those skilled in the art that other modifications can be made within the spirit of the disclosure. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the disclosure.

What is claimed is:

1. A system comprising:
a data network;
a first computing host, which is operably connected as a first node on said data network;
a second computing host, which is operably connected as a second node on said data network;
a test management infrastructure engine, which is operably connected to said first computing host; and
a user interface, which is operably connected to said test management infrastructure engine,
whereby the system components are configured to manage, deliver, execute, analyze, and act on a one or more test enabling the system to detect and act upon issues impacting components of the data networks used by system users.

2. The system of claim 1 wherein said test management infrastructure engine comprises:
an instruction definition engine;
an instruction database;
an instruction generator;
a result interpreter;
a result database;
a settings database
an action interface engine; and
a correlation and trending engine.

3. The system of claim 1 wherein said first computing host is configured as a Data Agent further comprising a dynamic set of computing processes and scripts operable on said first computing host which is operably connected to said data network.

4. The system of claim 1 wherein said second computing host is configured as a Data Agent further comprising a dynamic set of computing processes and scripts operable on said second computing host which is operably connected to said data network.

5. The system of claim 1 wherein said first computing host is a Data Agent that is a special-purpose dedicated hardware device that is operably connected to said data network.

6. The system of claim 1 wherein said second computing host is a Data Agent that is a special-purpose dedicated hardware device that is operably connected to said data network.

7. The system of claim 1 further comprising more than one Data Agent.

8. The system of claim 1 wherein the test management infrastructure engine is hardened to prevent unauthorized access, use, or control.

9. The system of claim 1 wherein the first computing host acting as a data agent is hardened to prevent unauthorized access, use, or control.

10. The system of claim 1 wherein the second computing host acting as a data agent is hardened to prevent unauthorized access, use, or control.

11. The system of claim 1 wherein the system is configured to perform method steps comprising:
providing instructions by the instruction generator to the data agent;
receiving by the data agent the instructions, acting based on the instructions, generating result and sending result to results interpreter;
receiving by the results interpreter the result;
processing by the results interpreter of the result;
writing of the interpreted result by the results interpreter to the result database;
mining of the interpreted result stored on the results database by the correlation and trending engine;
writing by the correlation and trending engine to the results database and instructions database;
performing actions by the action interface engine based upon the instructions database;
reading by the test definition engine of the instructions database;
and
updating by the test definition engine of instructions in the instructions database,
whereby the system performs performance and quality testing of data network communications systems.

12. A data agent apparatus for the monitoring, testing, and trending of data communications networks, the apparatus comprising:
a communications bus;
a microprocessor operably coupled with said communications bus;
an input/output subsystem operably coupled with the microprocessor;
a memory operably coupled with the microprocessor;
a storage operably coupled with the microprocessor; and
a network interface operably coupled with the microprocessor.

13. The data agent apparatus of claim 12 wherein said apparatus is hardened to prevent unauthorized access, use, or control.

14. The data agent apparatus of claim 12 wherein said apparatus further comprises:
an instruction definition engine;
an instruction database;
an instruction generator;
a result interpreter;
a result database;
a settings database
an action interface engine; and
a correlation and trending engine.

15. The data agent apparatus of claim 12 wherein said apparatus is configured to:
download instructions;
process the instructions and execute commands and processes;
record results to a results file; and
transmit the results.
